(19) United States
(12) Patent Application Publication
(10) Pub. No.: US 2007/0061474 A1
(43) Pub. Date: Mar. 15, 2007

(54) System and method for controlling output media sources in a shared document processing environment

(75) Inventors: Tony T. Quach, Anaheim, CA (US); Peter Tran, Garden Grove, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/224,570

(22) Filed: Sep. 12, 2005

(51) Int. Cl. G06F 15/16

(52) U.S. Cl. 709/229

(57) ABSTRACT

A system and method for reserving an output media source in a shared document processing device environment. A source reservation request is received from an associated user containing an output media source selection from among multiple available sources on a document processing device and authorization information. A document processing request, representing a selected document processing operation, is then received. This request includes data representing the identification of the source requesting the document processing operation and data representing a desired output media source. The document processing request data is then tested against the source reservation request data. Based upon the testing, the document processing operation is selectively processed by the associated document processing device.

### BACKGROUND OF THE INVENTION

This invention is directed to a system and method for document processing. More particularly, this invention is directed to a system and method for reserving an output media source in a shared document processing device environment.

Document processing devices, such as multifunction peripheral devices, are typically employed in network settings. When connected to the network, each device is accessible by a variety of different users. The general user will require access to a specific type of paper, such as 8½″×11″, while others require access to special preprinted forms, such as checks, statements, invoices and the like. As specialized forms and paper types are more expensive than the general paper, care must be taken to avoid waste, such as unintentional printing of a document on the specialized forms. To that end, multifunction peripheral devices are equipped with a variety of paper trays capable of holding different sizes and types of output media. However, a specialized form is likely to be letter size, i.e., 8½″×11″, which lead to mistakes by users when printing.

For example, the typical office user merely selects “letter size” paper when making copies, not knowing that another user has filled the “letter size” paper tray with accounting forms. When the typical user outputs his copy job, the original document is unwittingly reproduced on the accounting form, frustrating the typical user and wasting the more expensive preprinted form. Under these same circumstances, the user who has filled the tray with specialized forms now tries to print his document on the forms only to discover that all the forms have already been used by the typical user.

Various attempts have been made to overcome the aforementioned difficulties. However these attempts are time consuming and do not guarantee success. For example, a specialized user is able to manually insert, or feed, each sheet of paper into the device for output. Similarly, the typical user, not noticing that manual feed, which generally overrides paper trays, is active, is still faced with the same problems of outputting a document on the specialized forms. Therefore, if a user were only able to selectively reserve a paper tray for specialized forms or printing for a predetermined period of time or a predetermined number of output jobs, the efficiency of the device would increase dramatically while the cost decreases accordingly.

There is a need for a system and method for reserving an output media source in a shared document processing device environment.

### SUMMARY OF THE INVENTION

In accordance with the present invention, there is provided a system and method for document processing.

Further, in accordance with the present invention, there is provided a system and method for reserving an output media source in a shared document processing device environment.

Still further, in accordance with the present invention, there is provided a system and method for reserving and releasing output media sources in a shared document processing device environment.

Still further, in accordance with the present invention, there is provided a system for reserving an output media source in a shared document processing device environment. The system includes receiving means that receive a source reservation request from an associated user. The source reservation request includes media selection data representing the user selected output source from among multiple available sources on a document processing device and user identification data that represents a user authorized to use the selected output source. The system also includes receiving means that receive a document processing request representing a user selected document processing operation. The document request includes identification data representing the requesting source and data representing a desired output media source. This document request is then tested against the media selection data and the user identification data to generate an output. This output is then used to selectively process the selected document processing operation.

Still further, in accordance with the present invention, there is provided a method for reserving an output media source in a shared document processing device environment. The method begins with the receipt of a source reservation request from an associated user. The source reservation request includes a selected source of output media from among multiple available sources on a document processing device and user identification data representing the identity of a user authorized to use the selected output media source. A document processing request, representing a selected document processing operation, is then received. This request includes data representing the identification of the source requesting the document processing operation and data representing a desired output media source. The document processing request data is then tested against the source reservation request data. Based upon this testing, the selected document processing operation is selectively processed by the associated document processing device.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2A is a flow chart illustrating a tray reserve selection method in accordance with the present invention;

FIG. 2B is a flow chart illustrating a tray release selection method in accordance with the present invention;

FIG. 3 is a flow chart illustrating a tray reserve and release method in accordance with the present invention;

FIG. 4 is a template screen illustrating a tray reserve and release operation in accordance with the present invention;

FIG. 5 is a template screen illustrating a tray reserve and release operation in accordance with the present invention; and

FIG. 6 is an administrative template screen illustrating a tray reserve and release operation in accordance with the present invention.

### DETAILED DESCRIPTION OF THE PREFERRED EMBODIMENT

The present invention is directed to a system and method for document processing. More particularly, the present invention is directed to a system and method for reserving and releasing output media sources in a shared document processing device environment.

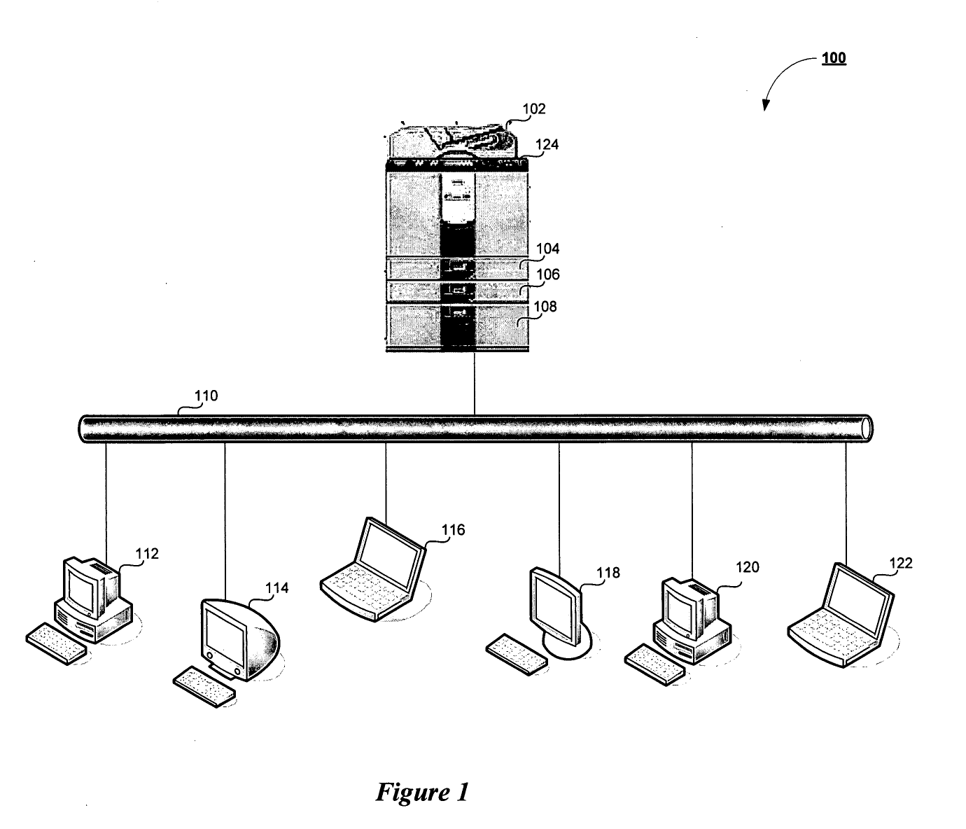

Turning now to FIG. 1, there is shown a diagram illustrating the system 100 in accordance with the present invention. As shown in FIG. 1, a user is able to access a document processing device, illustrated by a multifunction peripheral device 102, to generate or process image data. Those skilled in the art will appreciate that the document processing device is any suitable document processing device known in the art, such as a copier, printer, scanner, facsimile and the like, or any combination thereof. Suitable commercially available document processing devices include, but are not limited to, the Toshiba e-Studio Series Controller. The multifunction peripheral device 102 further includes at least one paper tray capable of storing various output media. As illustrated in FIG. 1, the multifunction peripheral device includes a first paper tray 104, a second paper tray 106 and a third paper tray 108. As will be understood by those skilled in the art, each of the paper trays 104-108 suitably contains a different paper size, such as A4, Letter, Ledger, Legal, A6 or the like, or the same size with varying orientations, such as portrait and landscape. The skilled artisan will appreciate that the sizes and orientations vary, depending upon the environment in which the multifunction peripheral device 102 operates and the present invention is equally applicable to any combination thereof.

In the preferred embodiment, the multifunction peripheral device 102 is suitably connected to a computer network 110. As will be appreciated by those skilled in the art, the computer network is any type of computer network known in the art, including the Internet, local area network, wide area network, and the like. The multifunction peripheral device 102 is suitably able to receive and transmit data over the network 110 using any communications link known in the art. As will be understood by those skilled in the art, the communications link is any means for communication between electronic devices, including for example and without limitation, an Ethernet based connection, a Token Ring connection, infrared connection, Wi-Fi connection, telephone connection, cellular connection, Bluetooth connection and the like or any combination of communication means thereof.

Also connected to the network 110 are a variety of user interface devices, illustrated in FIG. 1, as user devices 112, 114, 116, 118, 120, and 122. As will be understood by those skilled in the art, each of the user devices 112-122 are capable of submitting a document processing request to the multifunction peripheral device 102, including specialized processing requests and output media selection. In accordance with the present invention, a user is able to selectively reserve one of the available paper trays 104, 106, and 108 for a preselected period of time, or a predetermined number of outputs. Referring now to the user devices 112-122, a user, via user device 114, suitably requires that one or more documents be outputted on a specialized type of stationary, for example, invoice stationary, report card stationary, purchase order stationary, or other preprinted forms. To avoid the necessity of manually feeding the specialized forms into the multifunction peripheral device 102, or alternatively requesting that no other users access the multifunction peripheral device 102 until the forms have finished printing, the user via device 112 requests that one paper input tray 104 be reserved for exclusive use for a predetermined period of time, or alternatively, for a preselected number of document processing operations. In accordance with the present invention, the multifunction peripheral device 102 suitably determines if the user is authorized to reserve the tray 106. When the user is authorized to reserve the tray 104, the multifunction peripheral device 102 then determines for how long or the maximum number of copies for which the user is authorized to reserve the tray 104.

Once reserved, the user fills the reserved tray 104 with the corresponding number of preprinted specialized forms necessary to complete the request. As this tray 104 is reserved for the predetermined conditions, no other user will be able to print on the specialized forms other than the user via user device 112. During the reserved period, users via user devices 114-122, are able to submit document processing requests using one of the non-reserved paper trays, 106 and 108.

When the user has reserved the tray 104 for a predetermined period of time, but finishes printing prior to the elapsing of that time, the user is able to instruct, via the computer network 110, the multifunction peripheral device 102 to release the hold emplaced on the tray 104. Thus, once the invoices have been printed, the user releases the tray 104 back into general use by the other users accessing the network 110. The skilled artisan will appreciate that an authorized user at each user device 112-122 is equally capable of reserving and releasing any of the trays 104-108 containing output media on the multifunction peripheral device 102. The skilled artisan will further appreciate that the present invention is applicable to general printing as well as specialized forms. For example, a user via device 116, requires that several sets of documents be output on A4 paper. To avoid others printing on A4 while the multiple sets are being output, the user via device 116 reserves the A4 tray 104, for a predetermined number of copies. Once the several sets of documents have been outputted by the multifunction peripheral device 102, the A4 tray 104 is suitably released to the next reserve request, or to any general user requesting an A4 output media.

The user is also capable of accessing the multifunction peripheral device 102 directly via the communicatively coupled interface 124. In the preferred embodiment, the interface 124 is a touch screen interface, however any other suitable means of user interaction, such as an alphanumeric keypad or mouse are equally capable of being employed to receive instructions from the user. It will be understood by those skilled in the art that the interface 124 enables the multifunction peripheral device 102 to inform those walk-up users that a selected tray 104-108 is reserved and thereby prompt the walk-up user to select an alternate tray. In addition, the user interface 124 allows a user to reserve a tray 104-108 for document processing operations, for example, when making copies on a certain paper type and the like.

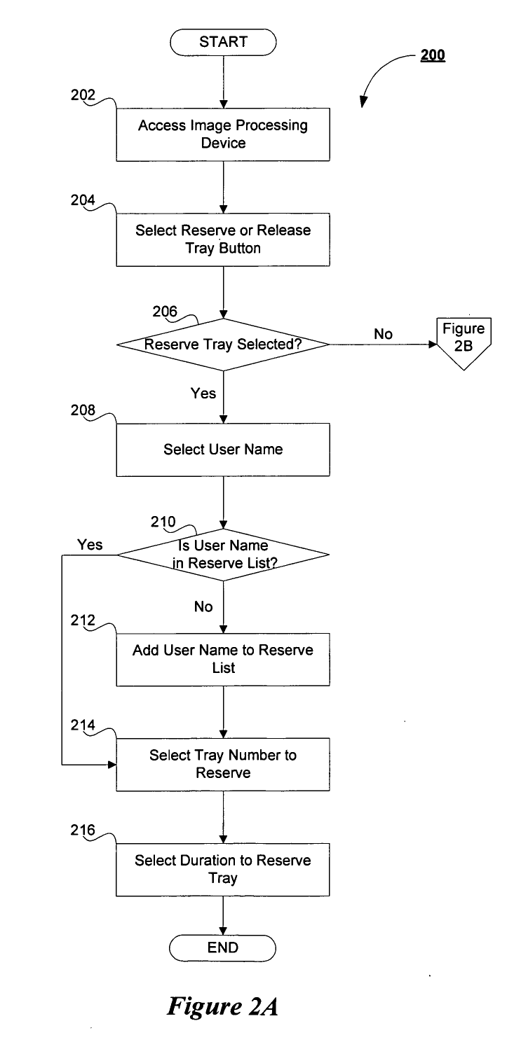

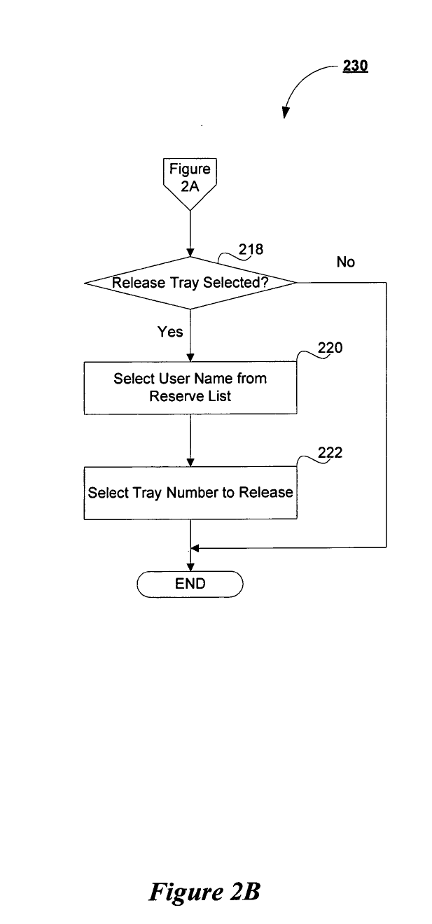

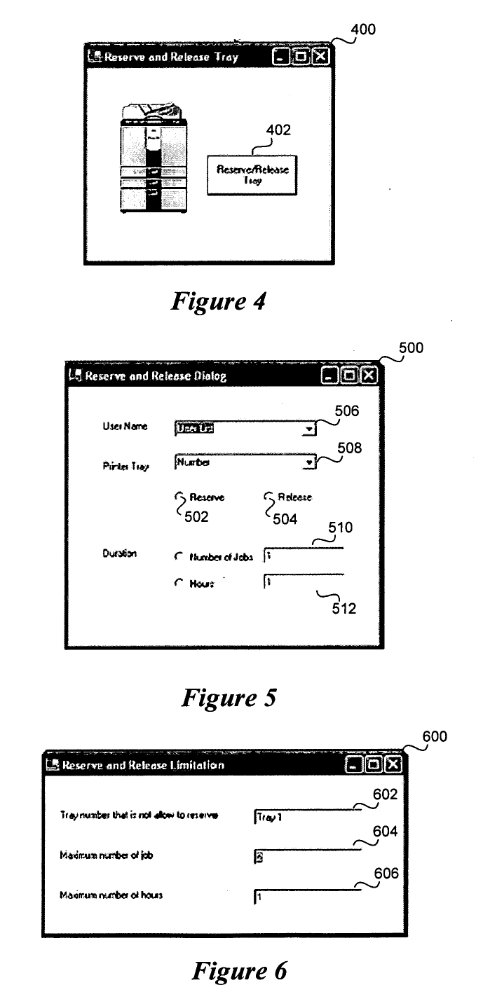

The present invention depicted by the system 100 will better be understood in connection with the flow chart 200 illustrated in FIG. 2A. The flow chart 200 illustrates one embodiment of the tray reserve method in accordance with the present invention. Beginning at step 202, a user accesses an image processing device, such as the multifunction peripheral device 102, via any means known in the art. At step 204, the user selects the reserve tray—release tray option via any means known in the art. FIG. 4 illustrates a graphical user interface template screen 400 that allows the user to select an icon 402 representing the reserve tray—release tray option. Upon selecting this icon 402, the method proceeds to a determination at step 206 to determine whether the user has selected to reserve a tray. Referring now to FIG. 5, there is shown a screen template 500 illustrating an exemplary embodiment for a graphical user interface that allows a user to select a user name. As shown in FIG. 5, the user is able to select to reserve a tray by selecting the reserve icon 502 or to release a reserved tray by selecting the release icon 504. When the user has selected to reserve a tray at step 206, flow progresses to step 208 and the user is prompted to select a user name. In accordance with FIG. 5, the user selects a user name from the pull-down list 506 of available user names.

A determination is then made at step 210 whether the selected user name is already present in the reserve list. When the user name is not present, the user is prompted to enter a user name at step 212 into the list and flow proceeds to step 214. Referring to FIG. 5, the user name 506 is capable of being manually entered in the form field 506, as well as being selected from the pull down menu. Returning to FIG. 2A, when the user name is already present in the reserve list, flow proceeds to step 214, wherein the user is prompted to select the tray number from which output media is to be drawn during processing. The template 500 of FIG. 5 illustrates at 508 the pull down menu containing the available trays for user selection. Upon selecting the desired output media tray, the user is prompted, at step 216, to select the duration for the reservation. As illustrated in FIG. 5, the user is able to select either a desired number of jobs 510, or a desired number of hours 512 within which the job is processed. Following the selection of the duration of the reserve request, the reserve request is initiated and the tray is held according to the selected parameters.

Returning to step 206, when it is determined that the user has not selected to reserve a tray, flow proceeds to the flow chart 230 of FIG. 2B. As shown in FIG. 2B, the tray release process begins at step 218, where a determination is made whether a release tray request is being made. When the user has finished using the device 102, i.e., no more jobs remain to be processed, but time or a number of jobs remain reserved to the user, the reserved tray must be released to enable other users to access the tray's contents. The skilled artisan will appreciate that the user need only wait for the elapsing of the remaining time before the tray is accessible again; however the user is allowed to release the tray prior to such elapsing. The user is prompted, at step 220, to select his user name from the reserve list of user names. The user is then prompted at step 222 to select the tray number that is to be released from its reserved state. The selected tray is then released from reserved status and is returned to usability by other users.

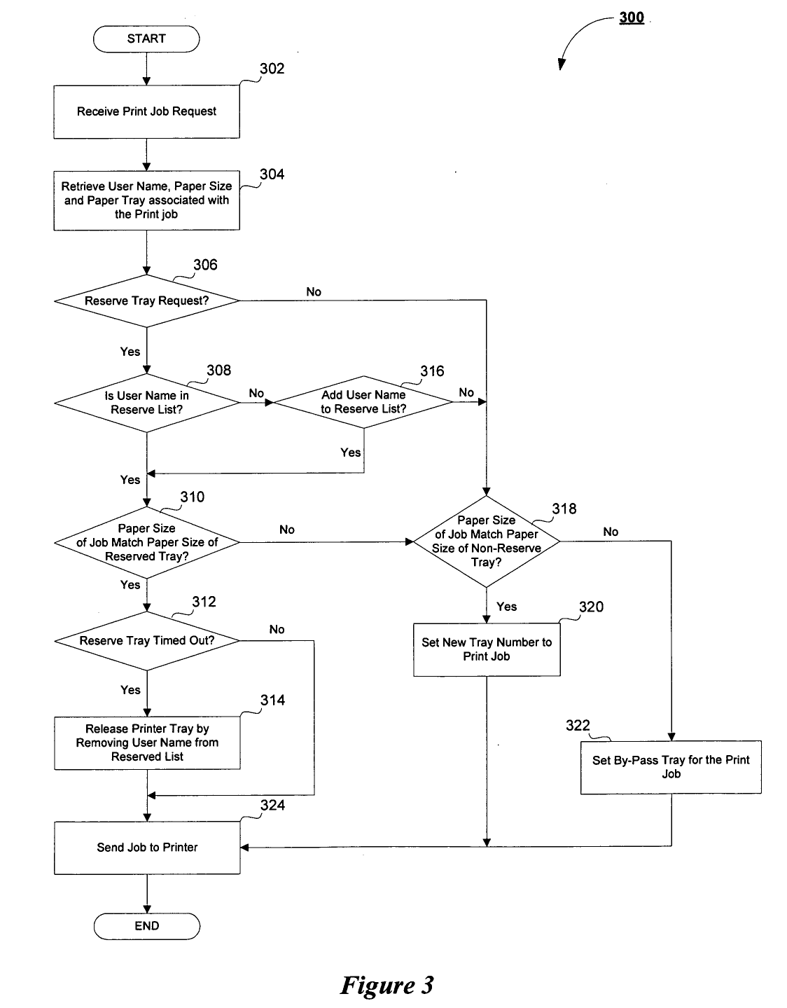

Turning now to FIG. 3, there is illustrated, there is depicted an exemplary flowchart 300 illustrating one embodiment of the method in accordance with the present invention. It will be appreciated by those skilled in the art that the flowchart 300 suitably describes operations of the present invention in accordance with the multifunction peripheral device 102 side. Beginning at step 302, the multifunction peripheral device 102 receives a document processing request, such as a print or copy request. At step 304, the user name, paper size and paper tray associated with the document processing request are retrieved from the submitted request and flow proceeds to step 306. At step 306 a determination is made whether the request contains a reserve tray request.

Upon a positive determination in step 306, flow proceeds to step 308 wherein a determination is made whether the user name, retrieved from the document processing request, is already present in the reserve list of users. It will be appreciated by those skilled in the art that in the preferred embodiment, the user is prompted to provide authentication information indicating authorization to reserve or to release a tray. When the user name is present in the reserve list, a determination is made at step 310 whether the paper size of the document processing request matches that of the reserved tray. Once it is determined that the sizes match, flow progresses to step 312 for a determination whether the reserve tray has already timed out. The skilled artisan will appreciate that this determination equates to ascertaining whether or not the reserved time has elapsed or whether the predetermined number of print or copy jobs have been output.

When it is determined that the reserve tray has timed out in step 312, the printer tray is released for access by other users. At step 314, the printer tray is released and the user name is removed from the reserve list. Once the tray has been released, the document processing request is forwarded to the printer engine at step 324 for output. When it is determined that time still remains in the reserve interval, or that a predetermined number of jobs remain to be carried out prior to expiration of the reserve interval, flow proceeds to step 324, wherein the document process request is sent to the printer engine for output.

Returning to step 306, when the received document processing request does not contain a reserve tray request, flow proceeds to step 318. At step 318, the document processing request is analyzed to determine if the paper size specified by the request matches the paper size available from a non-reserved paper tray. Should the paper sizes be incompatible, flow progresses to step 322, wherein the by-pass paper tray is used for the print or copy request. As will be understood by those skilled in the art, the by-pass tray typically represents the manual feed tray. The multifunction peripheral device 102 then processes the document processing request, designating the source of the output media as the by-pass paper tray, and transmits the document processing request to the printer engine for output thereon.

When the paper size of the document processing request matches the paper size contained in the non-reserved paper tray, the selected tray number is replaced with the non-reserve tray at step 320. The skilled artisan will understand that the device 102 automatically adjusts the received document processing request to designate the non-reserved, or available paper source, as the source for the output media. Once this change is made, the document processing request is sent to the printer engine at step 324 for output.

Returning to step 308, when it is determined that the user name does not appear in the reserve list, flow proceeds to step 316. At step 316 a determination is made whether the user name is to be added to the reserve list. When it is determined that the user name is to be added to the reserve list, the user name is added to the list in accordance with the method described above with respect to FIG. 2A. Following the addition of the user name to the reserve list, flow proceeds to step 310 and a determination is made whether the paper size requested matches the paper size available in the reserve tray. Processing continues in accordance with the method described above.

When it is determined at step 316 that the user name is not to be added to the reserve list, for example, the user lacks the proper authorization or authentication to be added to the list, flow proceeds to step 318. At step 318, a determination is made whether the paper size requested in the document processing request matches the size available in the non-reserved paper tray. When a match occurs, flow proceeds to step 320, wherein the non-reserved paper tray is used for output media instead of the reserved tray. The document processing request is then sent to the printer engine at step 324, with the non-reserved paper tray designated as the source for the output. When a match fails to occur at step 318, the by-pass paper tray is automatically designated as the source for output media at step 322. The document processing request is then forwarded to the printer engine at step 324 designating the by-pass tray as the source for output media.

The skilled artisan will appreciate that the foregoing processes and systems reserve paper sources for a selected user for a predetermined period of time, or alternatively, for a predetermined number of document processing jobs. In accordance with the present invention, the system allows an administrator to preset which trays cannot be reserved, the maximum amount of time a tray can be reserved, as well as the maximum number of document processing jobs for which a tray can be reserved. FIG. 6 illustrates a template screen 600 depicting the user interface available to the administrator to set these limits. As shown in FIG. 6, the screen 600 suitably includes a fill-in field 602 corresponding to administrator input tray limitations. The fill-in field 602 allows the administrator to designate which of the paper trays on the multifunction peripheral device 102 are not to be used for reserve tray printing. The fill-in field 604 allows the administrator to set the maximum number of document processing jobs for which a paper tray is able to be reserved. The fill-in field 606 allows the administrator to set the maximum amount of time for which a paper tray is able to be reserved.

The skilled artisan will further appreciate that the foregoing systems and methods are capable of employing authentication procedures as are known in the art. For example, the present invention is capable of being implemented such that only certain users are able to reserve paper trays and authentication procedures are suitably implemented to verify the user's rights to reserve a tray. In addition, the present invention is capable of being adapted to restrict different users to different reserve limitations, allowing one user or group of users to reserve a tray for one number of jobs or one period of time, while restricting another user or group of users to a lesser or greater number of jobs, or a shorter or longer period of time.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program, for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for reserving an output media source in a shared document processing device environment comprising:
means adapted for receiving a source reservation request from an associated user, which source reservation request includes,
media selection data representative of a selected source of output media of a plurality thereof corresponding to an associated document processing device, and
authorized user identification data representative of at least one authorized user of the selected source of output media;
means adapted for receiving a document processing request representative of a selected document processing operation, which document request includes,
requestor identification data representative of an identity of a source of a document processing request, and
media request data representative of a desired source of output media associated with the selected document processing operation;
testing means adapted for testing the requestor identification data and the media request data against the media selection data and the authorized user identification data; and
means adapted for selectively processing the selected document processing operation in accordance with an output of the testing means.

2. The system for reserving an output media source in a shared document processing device environment of claim 1, further comprising means adapted for selectively terminating the source reservation request in accordance with at least one of the group consisting of a reservation termination request and a tolling of a preselected duration.

3. The system for reserving an output media source in a shared document processing device environment of claim 1 wherein the testing means includes means adapted for selectively processing the selected document processing operation when the requestor identification data corresponds to the same user as the authorized user identification data.

4. The system for reserving an output media source in a shared document processing device environment of claim 3 further comprising means adapted to route processing of the selected document processing operation to an alternative output medium source in the event that the requestor identification data does not correspond to the authorized user identification data.

5. The system for reserving an output media source in a shared document processing device environment of claim 1, further comprising means adapted for selectively terminating the source reservation request in accordance with the completion of a preselected number of document processing operations.

6. A method for reserving an output media source in a shared document processing device environment comprising the steps of:
receiving a source reservation request from an associated user, which source reservation request includes,
media selection data representative of a selected source of output media of a plurality thereof corresponding to an associated document processing device, and
authorized user identification data representative of at least one authorized user of the selected source of output media;
receiving a document processing request representative of a selected document processing operation, which document request includes,
requestor identification data representative of an identity of a source of a document processing request, and
media request data representative of a desired source of output media associated with the selected document processing operation;
testing the requestor identification data and the media request data against the media selection data and the authorized user identification data; and
selectively processing the selected document processing operation in accordance with an output of the testing.

7. The method for reserving an output media source in a shared document processing device environment of claim 6, further comprising the step of selectively terminating the source reservation request in accordance with at least one of the group consisting of a reservation termination request and a tolling of a preselected duration.

8. The method for reserving an output media source in a shared document processing device environment of claim 6, further comprising the step of selectively processing the selected document processing operation when the requestor identification data corresponds to the same user as the authorized user identification data.

9. The method for reserving an output media source in a shared document processing device environment of claim 8, further comprising the step of routing processing of the selected document processing operation to an alternative output medium source in the event that the requestor identification data does not correspond to the authorized user identification data.

10. The method for reserving an output media source in a shared document processing device environment of claim 6, further comprising the step of selectively terminating the source reservation request in accordance with the completion of a preselected number of document processing operations.

11. A computer-readable medium of instructions with computer-readable instructions stored thereon for reserving an output media source in a shared document processing device environment comprising:
instructions for receiving a source reservation request from an associated user, which source reservation request includes,
media selection data representative of a selected source of output media of a plurality thereof corresponding to an associated document processing device, and
authorized user identification data representative of at least one authorized user of the selected source of output media;
instructions for receiving a document processing request representative of a selected document processing operation, which document request includes,
requestor identification data representative of an identity of a source of a document processing request, and
media request data representative of a desired source of output media associated with the selected document processing operation;
instructions for testing the requestor identification data and the media request data against the media selection data and the authorized user identification data; and
instructions for selectively processing the selected document processing operation in accordance with an output of the testing.

12. The computer-readable medium of instructions with computer-readable instructions stored thereon for reserving an output media source in a shared document processing device environment of claim 11, further comprising instructions for selectively terminating the source reservation request in accordance with at least one of the group consisting of a reservation termination request and a tolling of a preselected duration.

13. The computer-readable medium of instructions with computer-readable instructions stored thereon for reserving an output media source in a shared document processing device environment of claim 11, further comprising instructions for selectively processing the selected document processing operation when the requestor identification data corresponds to the same user as the authorized user identification data.

14. The computer-readable medium of instructions with computer-readable instructions stored thereon for reserving an output media source in a shared document processing device environment of claim 8, further comprising instructions for routing processing of the selected document processing operation to an alternative output medium source in the event that the requestor identification data does not correspond to the authorized user identification data.

15. The computer-readable medium of instructions with computer-readable instructions stored thereon for reserving an output media source in a shared document processing device environment of claim 11, further comprising instructions for selectively terminating the source reservation request in accordance with the completion of a preselected number of document processing operations.

16. A computer-implemented method for reserving an output media source in a shared document processing device environment comprising the steps of:
receiving a source reservation request from an associated user, which source reservation request includes,
media selection data representative of a selected source of output media of a plurality thereof corresponding to an associated document processing device, and
authorized user identification data representative of at least one authorized user of the selected source of output media;
receiving a document processing request representative of a selected document processing operation, which document request includes,
requestor identification data representative of an identity of a source of a document processing request, and
media request data representative of a desired source of output media associated with the selected document processing operation;
testing the requestor identification data and the media request data against the media selection data and the authorized user identification data; and
selectively processing the selected document processing operation in accordance with an output of the testing.

17. The computer-implemented method for reserving an output media source in a shared document processing device environment of claim 16, further comprising the step of selectively terminating the source reservation request in accordance with at least one of the group consisting of a reservation termination request and a tolling of a preselected duration.

18. The computer-implemented method for reserving an output media source in a shared document processing device environment of claim 16, further comprising the step of selectively processing the selected document processing operation when the requestor identification data corresponds to the same user as the authorized user identification data.

19. The computer-implemented method for reserving an output media source in a shared document processing device environment of claim 18, further comprising the step of routing processing of the selected document processing operation to an alternative output medium source in the event that the requestor identification data does not correspond to the authorized user identification data.

20. The computer-implemented method for reserving an output media source in a shared document processing device environment of claim 16, further comprising the step of selectively terminating the source reservation request in accordance with the completion of a preselected number of document processing operations.
